(19) United States
(12) Patent Application Publication
(10) Pub. No.: US 2026/0092422 A1
(43) Pub. Date: Apr. 2, 2026

(54) SCREW PILE WITH AN ANTI-TIP PANEL

(71) Applicant: Nextracker LLC, Fremont, CA (US)

(72) Inventors: Raghavendra Praveen Maddulapalli, Vijayawada (IN); Abhimanyu Anil Sable, Hyderabad (IN)

(21) Appl. No.: 19/345,410

(22) Filed: Sep. 30, 2025

Related U.S. Application Data
(60) Provisional application No. 63/700,941, filed on Sep. 30, 2024.

(51) Int. Cl. E02D 5/54; E02D 5/56; E02D 7/22; H02S 20/32

(52) U.S. Cl. CPC E02D 5/54; E02D 5/56; E02D 7/22; H02S 20/32; E02D 2600/40

(57) ABSTRACT

An anti-tip ground pile for a solar tracking system includes an elongate tube having a central longitudinal axis, one or more blades formed along the tube for engaging with a ground in which the ground pile is implanted, and a stabilizing panel rotatably engaged with the tube such that the panel is continuously rotatable around the entire tube. The stabilizing panel providing support to the tube to help prevent the tube from tipping over in soil in which the tube is implanted.

### RELATED APPLICATIONS

This application claims the benefit of U.S. Provisional Ser. No. 63/700,941 , filed Sep. 30, 2024, the entire contents of which are incorporated herein by reference.

### TECHNICAL FIELD

This disclosure relates generally to solar power generation systems, and more particularly, to support structures for solar arrays within a solar tracking system.

### BACKGROUND

One of the most significant, costly, and time-consuming aspects relating to the manufacture and installation of solar trackers is the use of piers to support the solar modules. These piers, typically C-channels, W-beams, I-beams, or the like, are driven deep into the ground using costly heavy machinery such as pile driving equipment or by casting the piers in-situ using costly micro-pile equipment. As can be appreciated, each process not only requires costly equipment, but also requires a significant amount of time to complete, driving up the cost of installing solar tracking systems.

Additionally, solar tracker systems employ a significant amount of bearing housing assemblies, piers, damper assemblies, amongst others, which create a significant load on the piers. The piers that hold the solar tracker systems may be exposed to extreme weather loads. As these piers are installed in a variety of soil types, some of which are softer soil types, extreme weather loads may cause the piers to move, thereby creating unalignment of the solar tracker systems.

In view of this, solar tracker piers and foundations that alleviate the unintended movement of the piers and thereby the solar tracker systems, are needed.

### SUMMARY

In general, the present disclosure relates to support structures for solar arrays within a solar tracking system. In a first example, an anti-tip ground pile for a solar tracking system may include an elongate tube extending longitudinally from a first end to a second end, the tube having an outer surface and having a central longitudinal axis. One or more blades formed along the tube, the blades for engaging with ground in which the ground pile is implanted, and a stabilizing panel rotatably engaged with the tube such that the panel is continuously rotatable around the entire tube. The stabilizing panel may be positioned along the central longitudinal axis at a longitudinal position closer to the first end than a longitudinal position of the one or more blades, the stabilizing panel providing support to the tube to help prevent the tube from tipping over in soil in which the tube is implanted.

Additionally or alternatively, the longitudinal position of the stabilizing panel may remain consistent when the tube rotates relative to the stabilizing panel.

Additionally or alternatively, the stabilizing panel may have a first and second opposing surfaces, the second opposing surface being radially outward of the first surface relative to the longitudinal axis, an orientation of the first and second surfaces relative to the longitudinal axis remaining consistent when the tube rotates relative to the stabilizing panel.

Additionally or alternatively, the stabilizing panel may have a first and second opposing surfaces, the second opposing surface being radially outward of the first surface relative to the longitudinal axis, the first surface tapering towards the second surface in a longitudinal direction towards the send end to form a wedge.

Additionally or alternatively, the stabilizing panel may have a first surface and a second surface, opposite the first surface, the second surface being radially outward of the first surface relative to the longitudinal axis by a thickness, the thickness being less than a height or width of the first surface or the second surface.

Additionally or alternatively, the stabilizing panel may have a first surface and a second surface, opposite the first surface, the second surface being radially outward of the first surface relative to the longitudinal axis, the stabilizing panel having a height measured in a directional parallel to the longitudinal axis and a width measured in a direction perpendicular to the longitudinal axis, and the tube having a diameter, the height and the width being greater than the diameter.

Additionally or alternatively, the stabilizing panel may connect to the tube via one or more u-brackets, the u-brackets riding in grooves in the tube, the grooves and the u-brackets cooperating to permit rotation of the panel relative to the tube while maintaining the orientation of the panel relative to central longitudinal axis of the tube.

Additionally or alternatively, the rotation of the tube relative to underlying ground may cause the blades to pull the tube further underground, the pulling of the tube further underground pulling the stabilizing panel underground.

Additionally or alternatively, the one or more blades may extend away a blade distance from the outer surface of the tube, the stabilizing panel is rotatable relative to the tube at an offset distance from the outer surface of the tube, and the blade distance is greater than the offset distance.

Additionally or alternatively, the one or more blades formed along the tube may include a helical blade formed adjacent to the second end of the tube.

Additionally or alternatively, the first end of the tube may include a first mounting hole, the first end of the tube and the mounting hole configured to engage with a motor that rotates the tube for implantation into the ground.

Additionally or alternatively, the first end of the tube may include a mount for attaching solar tracking components.

Additionally or alternatively, the one or more blades do not overlap longitudinally with the stabilizing panel.

In another example, an anti-tip ground pile for a solar tracking system may include an elongate tube extending longitudinally from a first end to a second end, the tube having an outer surface and a central longitudinal axis, one or more grooves formed in the elongate tube, one or more helical blades formed along the tube, the one or more helical blades for engaging with ground in which the ground pile is implanted, and a stabilizing panel rotatably engaged with the tube via one or more u-brackets, the u-brackets configured to ride within the one or more grooves in the elongate tube such that the panel is continuously rotatable around the entire tube, the stabilizing panel providing support to the tube to help prevent the tube from tipping over in soil in which the tube is implanted.

Additionally or alternatively, the longitudinal position of the stabilizing panel may remain consistent when the tube rotates relative to the stabilizing panel.

Additionally or alternatively, the stabilizing panel may be positioned along the central longitudinal axis at a longitudinal position closer to the first end than a longitudinal position of the one or more helical blades.

Additionally or alternatively, the one or more helical blades do not overlap longitudinally with the stabilizing panel.

In another example, a method of placing an anti-tip ground pile may include positioning the anti-tip ground pile adjacent to a ground in which the anti-tip ground pile is to be implanted. The anti-tip ground pile may include an elongate tube extending longitudinally from a first end to a second end, the tube having an outer surface and having a central longitudinal axis, one or more blades formed along the tube, the blades for engaging with ground in which the ground pile is implanted, and a stabilizing panel rotatably engaged with the tube such that the panel is continuously rotatable around the entire tube, the stabilizing panel being positioned along the central longitudinal axis at a longitudinal position closer to the first end than a longitudinal position of the one or more blades. The method may further include rotating the anti-tip ground pile relative to the ground causing the one or more blades to engage with the ground and pull the anti-tip ground pile underground, wherein the stabilizing panel remains stationary relative to the elongate tube when the anti-tip ground pile is rotated.

Additionally or alternatively, further rotation of the anti-tip ground pile further pulls the stabilizing panel underground.

Additionally or alternatively, the stabilizing panel may have a first and second opposing surfaces, the second opposing surface being radially outward of the first surface relative to the longitudinal axis, an orientation of the first and second surfaces relative to the longitudinal axis remaining consistent when the tube rotates relative to the stabilizing panel.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure.

FIG. 2 is a perspective view of an example screw pile in accordance with the present disclosure.

FIG. 3 is a front side view of the example screw pile as in FIG. 2.

FIG. 4 is a side view of the example screw pile as in FIG. 2.

FIG. 5A is an enlarged side view of a portion of the screw pile shown in box 5, as in FIG. 4.

FIG. 5B is an enlarged side view of a portion of the screw pile shown in box 5, as in FIG. 4, with the anti-tip panel removed.

FIG. 5C is an enlarged perspective view of a portion of the screw pile shown in box 5, as in FIG. 4.

FIG. 6A is a perspective view of an anti-tip panel in accordance with the present disclosure.

FIG. 6B is a side view of the anti-tip panel as in FIG. 6A.

FIG. 6C is a front side view of the anti-tip panel as in FIG. 6A.

FIG. 7A is a perspective view of an example screw pile in accordance with the present disclosure.

FIG. 7B is a front side view of the example screw pile as in FIG. 7A.

FIG. 7C is a side view of the example screw pile as in FIG. 7A.

FIG. 8 is an enlarged view of a portion of the screw pile shown in box 8, as in FIG. 7A.

FIG. 9 is an enlarged rear view of the portion of the screw pile as in FIG. 8.

FIG. 10A is a perspective view of an example screw pile in accordance with the present disclosure.

FIG. 10B is a front side view of the example screw pile as in FIG. 10A.

FIG. 10C is a side view of the example screw pile as in FIG. 10A.

FIG. 11A is an enlarged view of a portion of the screw pile shown in box 11, as in FIG. 10A.

FIG. 11B is an enlarged rear view of the portion of the screw pile as in FIG. 11A.

FIG. 11C is a cross-sectional view of the portion of the screw pile as in FIG. 11B, take at line 11C-11C.

FIG. 12A is a perspective view of an anti-tip panel as in FIGS. 11A to 11B.

FIG. 12B is a cross-sectional view of the anti-tip panel as in FIG. 12A, taken at line 12-12.

FIGS. 13A to 13C illustrate a method of use for an example screw pile in accordance with the present disclosure.

### DETAILED DESCRIPTION

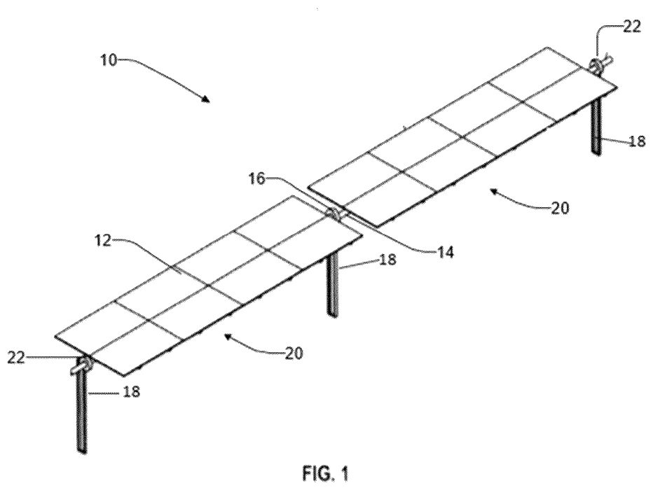

The present disclosure is directed to ground piles for a solar tracking system. FIG. 1 is an elevation view of a common arrangement of a solar tracker 10 provided in accordance with the present disclosure. The solar tracker 10 may be formed of a plurality of bays 20 defined by the distance between ground piles 18 (generally referenced herein as piles 18). FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Twisting of the torque tube 14 would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

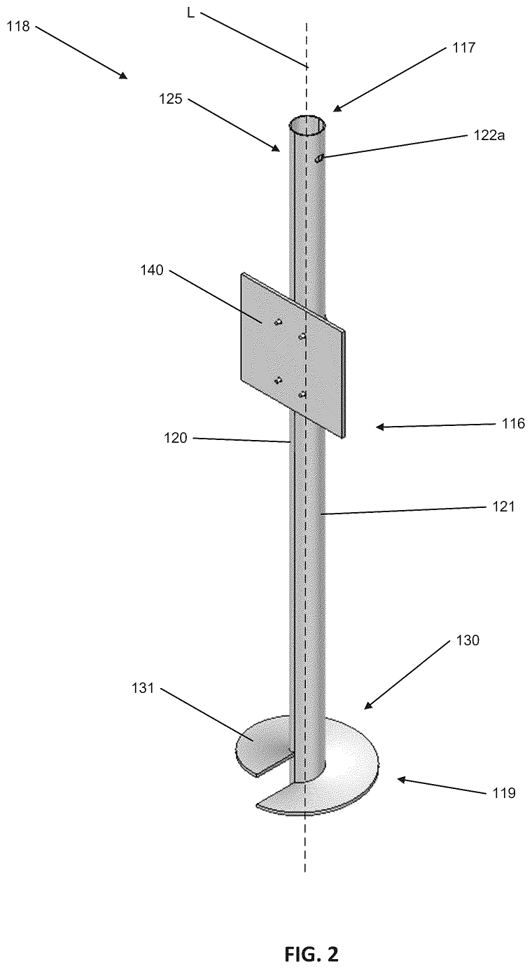

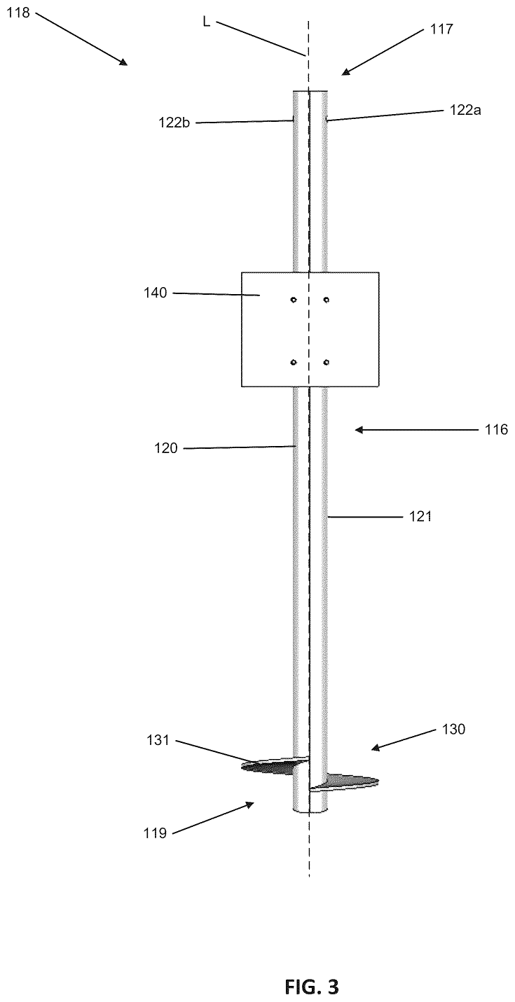

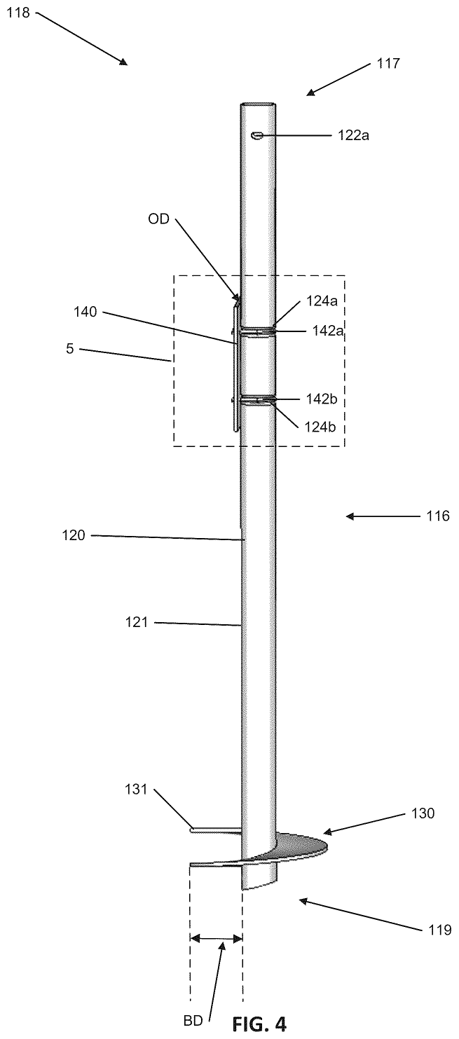

FIG. 2 is a perspective view of an example screw pile 118 in accordance with the present disclosure, FIG. 3 is a front side view of the screw pile 118, and FIG. 4 is a side view of the screw pile 118. The pile 118 may be an example of the pile 18 as in FIG. 1. As shown in FIGS. 2 to 4, the pile 118 may include an elongate tube 120 extending longitudinally from a first end 117 to a second end 119, and having a central longitudinal axis L. In some cases, the first end 117 of the tube 120 may be open and the second end 119 of the tube 120 may be open. In other cases, the first end 117 of the hollow tube 120 may be closed, and the second end 119 of the hollow tube may be closed. In some cases, one of the first end 117 or the second end 119 may be open and the other of the first end 117 or the second end 119 may be closed.

In some cases, the first end of the tube 120 may include a mount 125 for attaching solar tracking components. The mount 125 may include one or more mounting holes 122 that may be positioned proximate the first end 117. The one or more mounting holes 122 may extend through the hollow tube 120. While only two mounting holes 122a, 122b (generally referenced herein as mounting holes 122) are shown in FIG. 3, it may be contemplated that the pile 118 may include four mounting holes, six mounting holes, twelve mounting holes, twenty mounting holes, or any suitable number of mounting holes as desired. The mounting holes 122 may be used to attach solar tracking components such as for example, the bearings 22 and the drive mechanism 16, as shown in FIG. 1. In some cases, the mounting holes 122 may be configured to mount an adapter which may be used to drive the pile 118 into the ground.

As shown in FIGS. 2 to 4, the pile 118 may include one or more blades 130 formed along the tube 120. The design of the one or more blades 130 may include a helical blade 131. While it is shown in FIGS. 2 to 4 that there is one helical blade 131, it may be contemplated that there may be two, three, four, six, or any number of blades as desired. The helical blade 131 may be formed adjacent or closer to the second end 119 of the tube 120. The helical blade 131 may be configured for engaging with the ground in which the pile 118 is implanted by being screwed or threaded into the ground to anchor the solar tracker 10. The helical blade 131 may extend a single or multiple revolutions around the longitudinal axis L. The helical blade 131 may extend away from the longitudinal axis L of the hollow tube 120, and may also extend complete or partial revolutions around the longitudinal axis L. In some examples, the one or more blades 130 may extend a blade distance BD away from the outer surface 121 of the tube 120. The blade distance BD may be about 1 inch to about 6 inches. In some cases, the blade distance BD may be about 1.5 inches, 2, inches, 2.5 inches, 3 inches, 3.5 inches, 4 inches, 4.5 inches, 5 inches, 5.5 inches, or any other suitable blade distance BD. In some examples, the blade distance BD may be less than 1 inch or greater than 6 inches. While it is shown that the one or more blades 130 of the tube 120 are located along the longitudinal axis L of the hollow tube 120 closer to the second end 119, it may be contemplated that the one or more blades 130 may be located adjacent or closer to the first end 117, a central portion 116, or any other suitable portion along the longitudinal axis L of the hollow tube 120. While it is shown that the one or more blades 130 are helical blades 131, it may be contemplated that other types of blades may be used. Such as for example, angled blades, helical ridges, vertical ridges, spade blades, and paddle blades. These are just examples.

The pile 118 may be formed from aluminum, brass, carbon, stainless steel, copper, or other metal alloys. In some cases, the pile 118 may be formed via a hydroforming process. In such cases, the pile 118 may be formed of a material and a thickness appropriate for forming the particular components (e.g., blades) described herein. In some cases, the pile 118 may be formed via extrusion, welding, molding, and or any other suitable process. The addition of retention features (e.g., blades 130) to the pile 118 during the manufacturing process may be advantageous in diverse soil conditions soil conditions (e.g., sandy soil, clay soil, silt soil, peat soil, loam soil, among others) by providing reliable support for solar trackers 10 in rural and/or urban environments.

The tube 120 may include a circular cross-section, and the first end 117 of the hollow tube 120 and the second end 119 of the hollow tube 120 include the same or a similar outer diameter, as shown in FIGS. 2 to 4. Although this may not always be the case. In some cases, the first end 117 may have an outer diameter that is different than an outer diameter of the second end 119 (e.g., smaller than or larger than). In some cases, the tube 120 may include a hexagonal cross-section, a square cross-section, a rectangular cross-section, a triangular cross-section, a W-cross-section, a polygonal cross-section, or the like. In some cases, a cross-section of the one or more blades 130 may be non-circular in shape as the blades 130 extend in an outward direction from the longitudinal axis L of the tube 120. Although this may not always be the case. In some cases, the cross-section of the blades 130 may include a circular cross-section. In other cases, the cross-section of the blades 130 may include an oval cross-section, a polygonal cross-section, or any other suitable cross-section as desired.

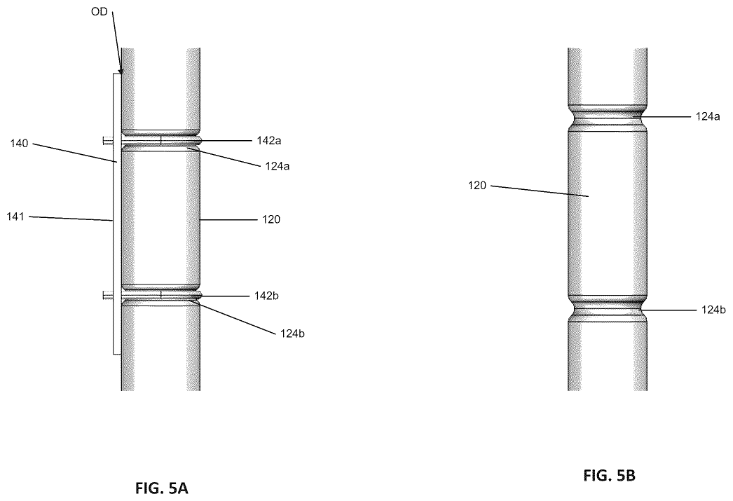

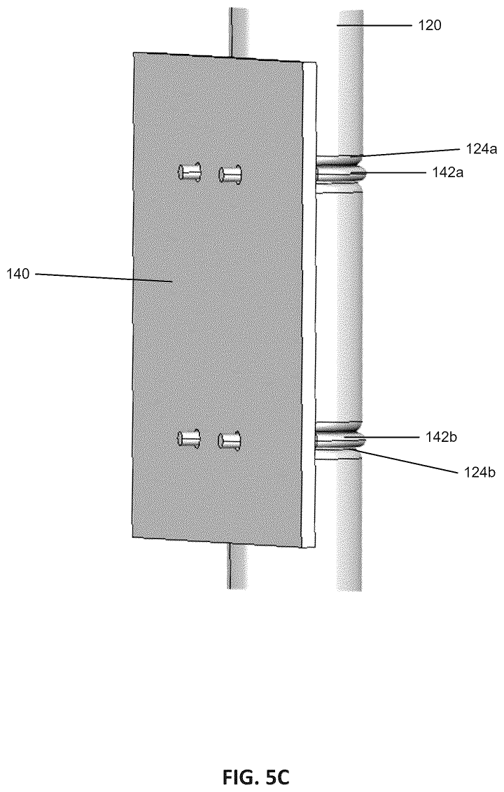

Further, a stabilizing panel 140 (generally referred to herein as panel 140) may be rotatably engaged with the tube 120. The panel 140 may include a first surface 141 and a second surface 143 opposite the first surface 141. The second, opposing surface 143 may be radially outward of the first surface 141 relative to the longitudinal axis L of the tube 120. The tube 120 may include one or more grooves 124a, 124b (shown further in FIGS. 5A to 5C). The stabilizing panel 140 may connect to the tube 120 via one or more u-brackets 142a, 142b that may ride within the one or more grooves 124a, 124b, respectively. The one or more grooves 124a, 124b and the one or more u-brackets 142a, 142b may cooperate to permit rotation of the panel 140 relative to the tube 120 while maintaining the orientation of the panel 140 relative to the central longitudinal axis L of the tube 120, such that the panel 140 may be continuously rotatable around the entire tube 120.

In some examples, the stabilizing panel 140 may be positioned along the central longitudinal axis L at a longitudinal position closer to the first end 117 than a longitudinal position of the one or more blades 130. In other examples, the panel 140 may be positioned along the central longitudinal axis L at a longitudinal position closer to the central portion 116. The position of the panel 140 may be such that the one or more blades 130 will not overlap longitudinally with the stabilizing panel 140. The longitudinal position of the stabilizing panel 140 may remain consistent when the tube 120 rotates relative to the stabilizing panel 140.

FIG. 5A is an enlarged side view of a portion of the pile 118 shown in box 5, FIG. 5B is an enlarged side view of a portion of the pile 118 shown in box 5, with the stabilizing panel 140 removed, and FIG. 5C is an enlarged perspective view of a portion of the pile 118 shown in box 5. As discussed, the panel 140 may include the first surface 141 and the second surface 143 opposite the first surface 141. The second, opposing surface 143 may be radially outward of the first surface 141 relative to the longitudinal axis L of the tube 120. The tube 120 may include the one or more grooves 124a, 124b. The stabilizing panel 140 may connect to the tube 120 via the one or more u-brackets 142a, 142b that may ride within the one or more grooves 124a, 124b, respectively, as shown in FIGS. 5A and 5C. The u-brackets 142a, 142b are positioned within the grooves 124a, 124b such that the u-brackets 142a, 142b move freely and independent of the tube 120. In some examples, the stabilizing panel 140 is rotatable relative to the tube 120 at an offset distance OD from the outer surface 121 of the tube 120, as shown in FIG. 5A. In some examples, the blade distance BD (FIG. 4) is greater than the offset distance OD. In other examples, the blade distance BD is equal to or less than the offset distance OD.

As shown in FIG. 5C, the panel 140 may include a first bore 144a, a second bore 144b, a third bore 144c, and a fourth bore 144d, generally referred to herein as bores 144. The one or more u-brackets 142a, 142b may be configured to pass through the bores 144 and engage the first surface 141 of the panel 140 to couple the panel 140 to the tube 120. While it is shown that there are four bores 144, it may be contemplated that there may be two bores, six bores, eight bores, twelve bores, or any other suitable number of bores as desired.

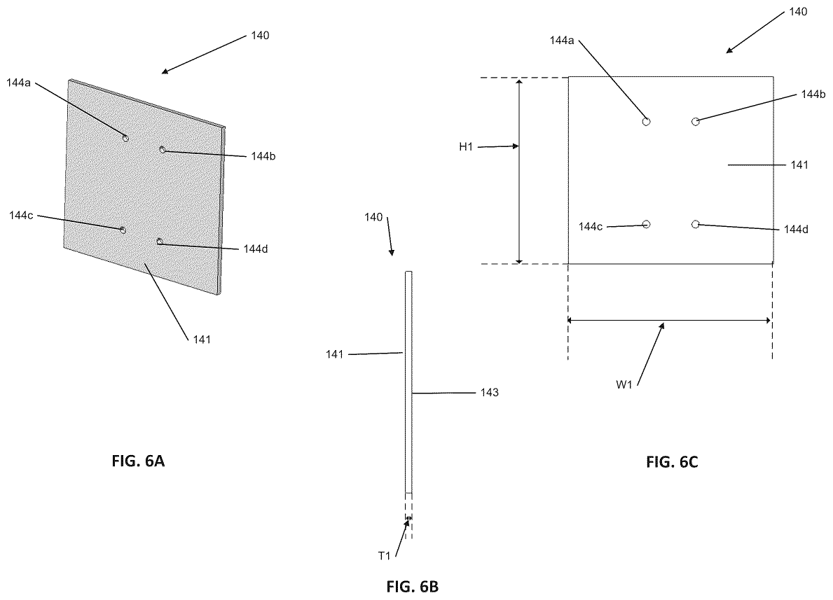

FIG. 6A is a perspective view of a stabilizing panel 140, FIG. 6B is a side view of the stabilizing panel 140, and FIG. 6C is a front side view of the stabilizing panel 140. As shown in FIGS. 6B and 6C, the second surface 143 of the panel 140 may be radially outward from the first surface 141 relative to the longitudinal axis L by a thickness T₁. The thickness T₁ may be less than a height H₁ or width W₁ of the first surface 141 or the second surface 143. The height H₁ of the panel 140 may be measured in a directional parallel to the longitudinal axis L of the tube 120, and the width W₁ may be measured in a direction perpendicular to the longitudinal axis L of the tube 120. In some examples, the height H₁ and the width W₁ of the panel 140 may be greater than a diameter of the tube 120. In some examples, the height H₁ may be the same as the width W₁ of the panel 140. In some examples, the height H₁ of the panel 140 may be less than the width W₁ of the panel 140. In other examples, the height H₁ may be greater than the width Wi of the panel 140.

In some examples, the first surface 141 may taper towards the second surface 143 in a longitudinal direction towards the second end 119 of the tube 120 to form a wedge. In some examples, an orientation of the first surface 141 and the second surface 143, relative to the longitudinal axis L remain consistent when the tube 120 rotates relative to the stabilizing panel 140.

The stabilizing panel 140 may be formed from aluminum, brass, carbon, stainless steel, copper, or other metal alloys. In some examples, the panel 140 may include a square cross-section. In other examples, the panel 140 may include a hexagonal cross-section, a rectangular cross-section, a triangular cross-section, a circular cross-section, a polygonal cross-section, or the like.

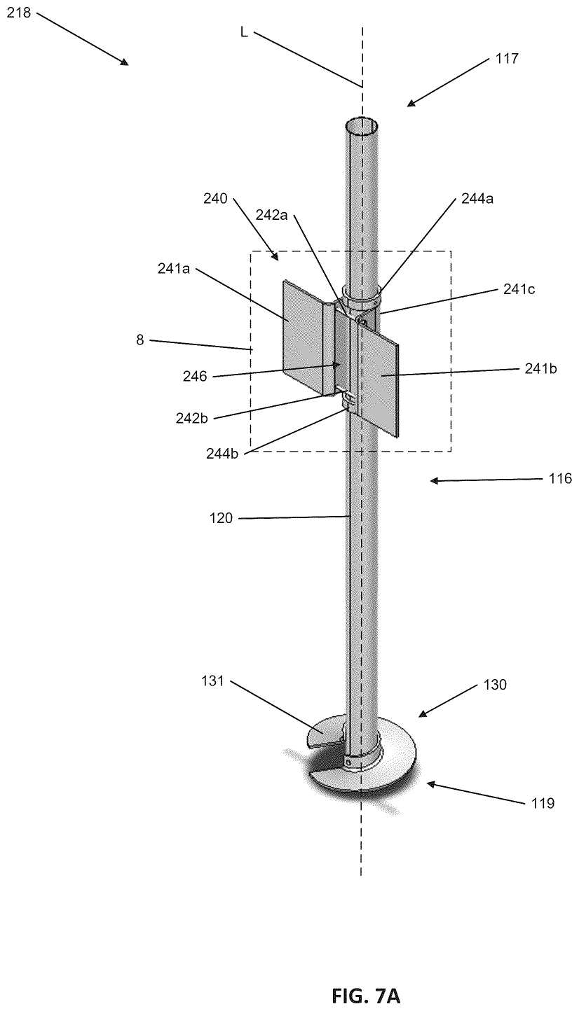

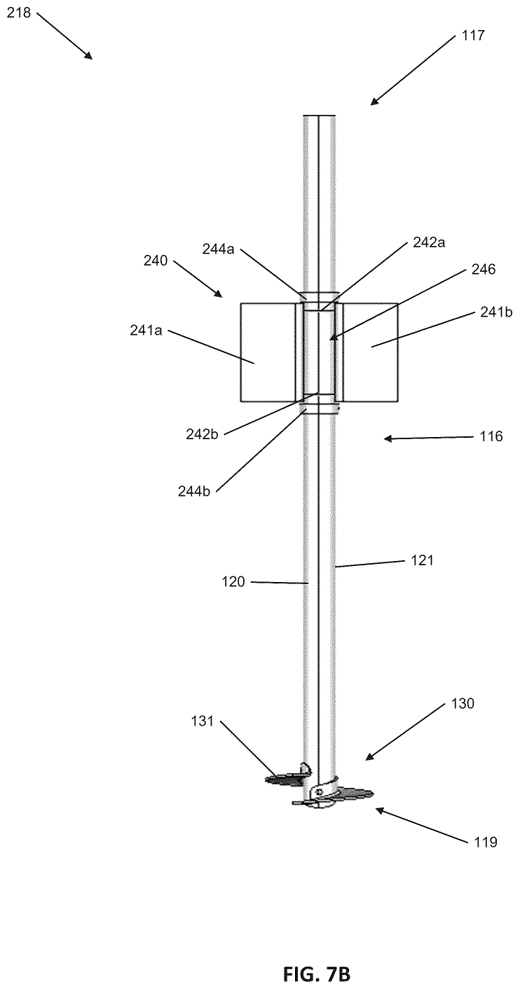

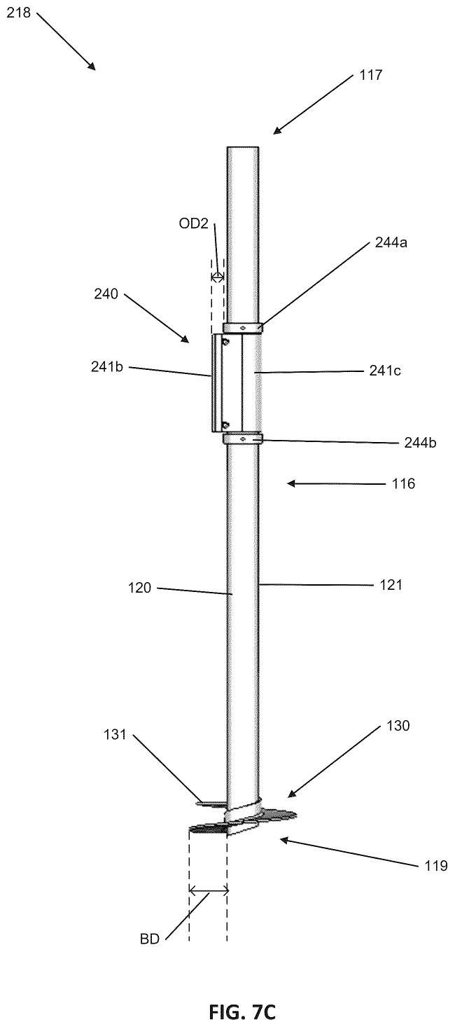

FIG. 7A is a perspective view of another example of a screw pile 218 in accordance with the present disclosure, FIG. 7B is a front side view of the screw pile 218, and FIG. 7C is a side view of the screw pile 218. The screw pile 218 shown in FIGS. 7A-7C is like the screw pile 118, as the pile 218 may include the elongate tube 120 extending longitudinally from the first end 117 to the second end 119, and having the central longitudinal axis L, as described herein. Further, the pile 218 may include the one or more blades 130 formed along the tube 120, and the design of the one or more blades 130 may include the helical blade 131, as described herein.

The screw pile 218 differs from pile 118 in that the screw pile 218 may include a stabilizing panel 240. The stabilizing panel 240 (generally referred to herein as panel 240) may be rotatably engaged with the tube 120 while maintaining a stationary position relative to the longitudinal axis L of the tube 120. The panel 240 may include a first portion 241a, a second portion 241b, and a third portion 241c. The second portion 241b may extend in an opposing direction lateral to the first portion 141a and with the longitudinal axis L of the tube 120 between (either while offset therefrom or when directly between). The third portion 241c may include a shape configured to fit around the outer perimeter of the tube 120. The third portion may, for instance, be U-shaped, C-shaped, or other shape that permits rotation of the third portion 241c around the outer perimeter of the tube 120. One end of the U-shape, C-shape, or otherwise of the third portion 241c may connect to the first portion 241a and the other end to second portion 241b. Thus, the third portion 241c may be configured to wrap around the tube 120 and couple the first portion 241a to the second portion 241b. A gap 246 may or may not be present. As shown in FIGS. 7A to 9, the third portion 241c may include a U-shape. In some examples, the third portion 241c may include a hexagonal shape, a square shape, a rectangular shape, a triangular shape, a polygonal shape, or any other shape that still permits rotation about the tube 120.

The pile 218 may be formed from aluminum, brass, carbon, stainless steel, copper, or other metal alloys. In some cases, the pile 218 may be formed via a hydroforming process. In such cases, the pile 218 may be formed of a material and a thickness appropriate for forming the particular components (e.g., blades) described herein. In some cases, the pile 218 may be formed via extrusion, welding, molding, and or any other suitable process. The addition of retention features (e.g., blades 130) to the pile 218 during the manufacturing process may be advantageous in diverse soil conditions soil conditions (e.g., sandy soil, clay soil, silt soil, peat soil, loam soil, among others) by providing reliable support for solar trackers 10 in rural and/or urban environments.

The stabilizing panel 240 may connect to the tube 120 via one or more bolts 242a, 242b that may extend across the gap 246 from the first portion 141a to the second portion 141b. Thus, the third portion 241c and the one or more bolts 242a, 242b work together to couple the panel 240 to the tube 120 while permitting rotation of the panel 240 relative to the tube 120.

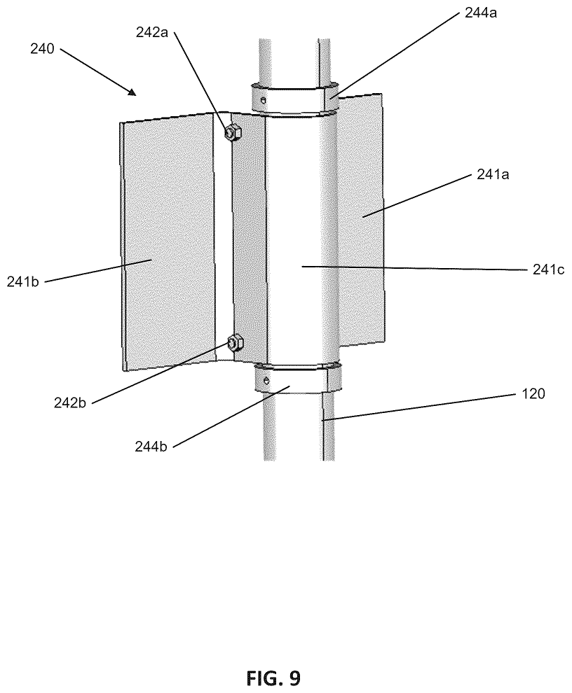

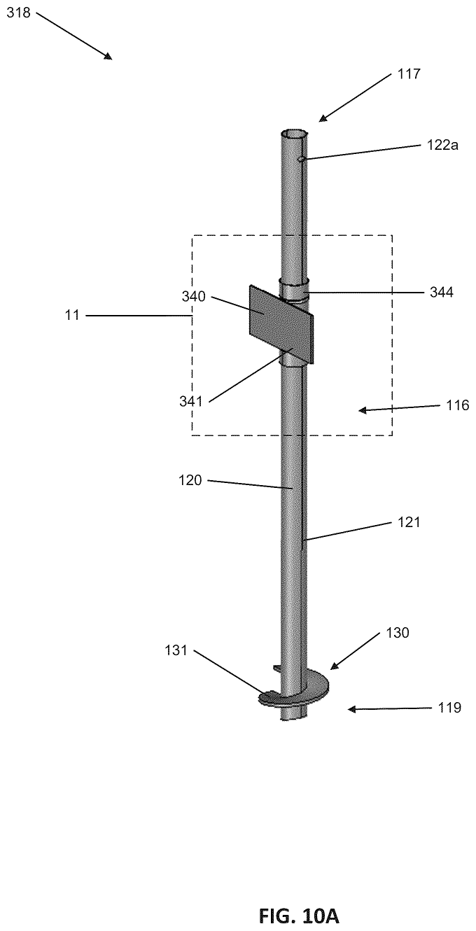

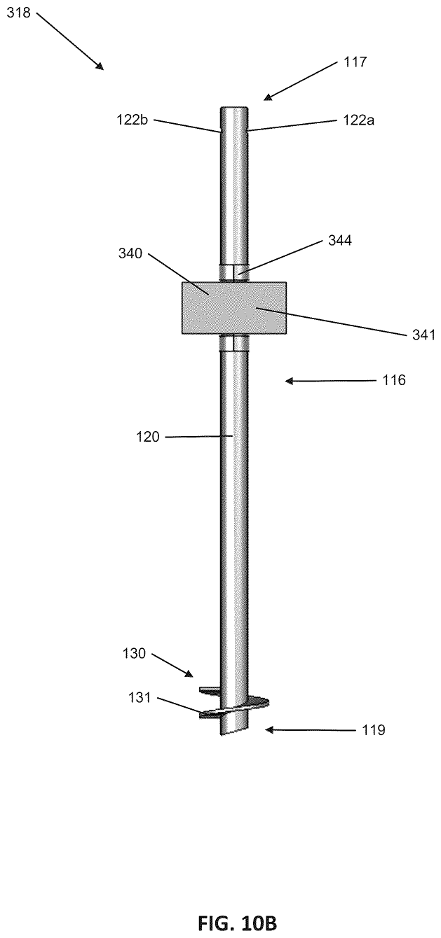

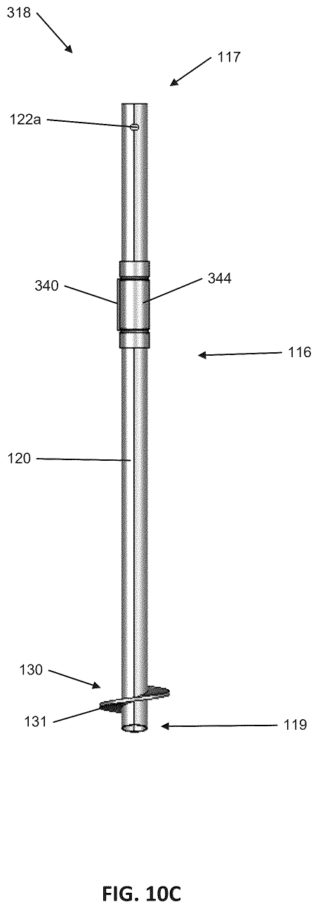

The tube 120 may include a first ring bracket 244a and a second ring bracket 244b (shown further in FIGS. 9 and 10). First ring bracket 244a is located on one axial side of panel 240 and second ring bracket 244b is located on the opposite axial side of panel 240. First ring bracket 244a and second ring bracket 244b have a larger radius than the tube 120 and a radius that extends further away from the central axis L than third portion 241c. By extending further outward from longitudinal axis L than the third portion 241c, first ring bracket 244a and second ring bracket 244b function as axial stops for panel 240 that maintain the panel 240 axially between the first ring bracket 244a and the second ring bracket 244b.

First ring bracket 244a and second ring bracket 244b may be formed in many different ways and in many different shapes, including by attaching a band around tube 120 or by forming an enlarged sections integrally with tube 120. First ring bracket 244a and second ring bracket 244b need not be continuous around tube 120 and may be formed of one or more discrete sections formed on the tube 120.

The first ring bracket 244a and the second ring bracket 244b, and the one or more bolts 242a, 242b may cooperate to permit rotation of the panel 240 relative to the tube 120 while maintaining the orientation of the panel 240 relative to the central longitudinal axis L of the tube 120, such that the panel 240 may be continuously rotatable around the entire tube 120.

In some examples, the stabilizing panel 240 may be positioned along the central longitudinal axis L at a longitudinal position closer to the first end 117 than a longitudinal position of the one or more blades 130. In other examples, the panel 240 may be positioned along the central longitudinal axis L at a longitudinal position closer to the central portion 116. The position of the panel 240 may be such that the one or more blades 130 will not overlap longitudinally with the stabilizing panel 240. The longitudinal position of the stabilizing panel 240 may remain consistent when the tube 120 rotates relative to the stabilizing panel 240.

In some examples, the stabilizing panel 240 is rotatable relative to the tube 120 at an offset distance OD₂ from the outer surface 121 of the tube 120, as shown in FIG. 7C. In some examples, the blade distance BD (FIG. 7C) is greater than the offset distance OD₂. In other examples, the blade distance BD is equal to or less than the offset distance OD₂.

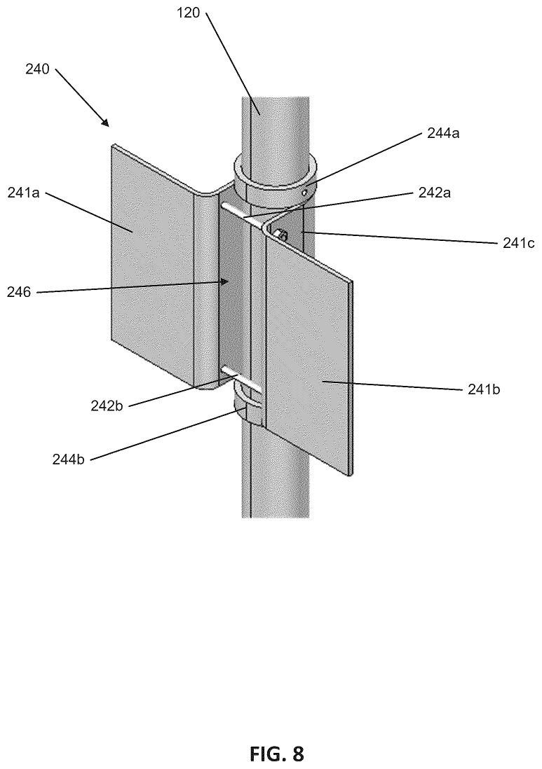

FIG. 8 is an enlarged view of a portion of the screw pile 118 shown in box 8, and FIG. 9 is an enlarged rear view of the portion of the screw pile 118 as in FIG. 8. As discussed, the panel 240 may include the first portion 241a, the second portion 241b, and the third portion 241c. The first portion 241a and the second portion 241b may extend in opposing directions relative to the third portion 241c and opposing directions away from longitudinal axis L of the tube 120. to the first portion 141a relative to the longitudinal axis L of the tube 120, with a gap 246 therebetween. The gap 246 may be formed via the third portion 241c of the panel 240, as the third portion 241c may include a shape configured to fit around the outer circumference of the tube 120. The tube 120 may include a first ring bracket 244a and a second ring bracket 244b. The stabilizing panel 240 may connect to the tube 120 via one or more bolts 242a, 242b that may extend across the gap 246 from the first portion 141a to the second portion 141b. Thus, the third portion 241c and the one or more bolts 242a, 242b work together to couple the panel 240 to the tube 120.

The first portion 241a, the second portion 241b, and the third portion 241c of the panel 240 may be formed via a process such as stamping, casting, hydroforming, or the like. In some cases, the first portion 241a, the second portion 241b, and the third portion 241c of the panel 240 may be formed as separate pieces that may be coupled together via bolts, welding, or the like.

FIG. 10A is a perspective view of another example screw pile 318 in accordance with the present disclosure. FIG. 10B is a front side view of the example screw pile 318, and FIG. 10C is a side view of the example screw pile 318. The screw pile 318 shown in FIGS. 10A-10C is like the screw pile 118, as the pile 318 may include the elongate tube 120 extending longitudinally from the first end 117 to the second end 119, and having the central longitudinal axis L, as described herein. Further, the pile 318 may include the one or more blades 130 formed along the tube 120, and the design of the one or more blades 130 may include the helical blade 131, as described herein.

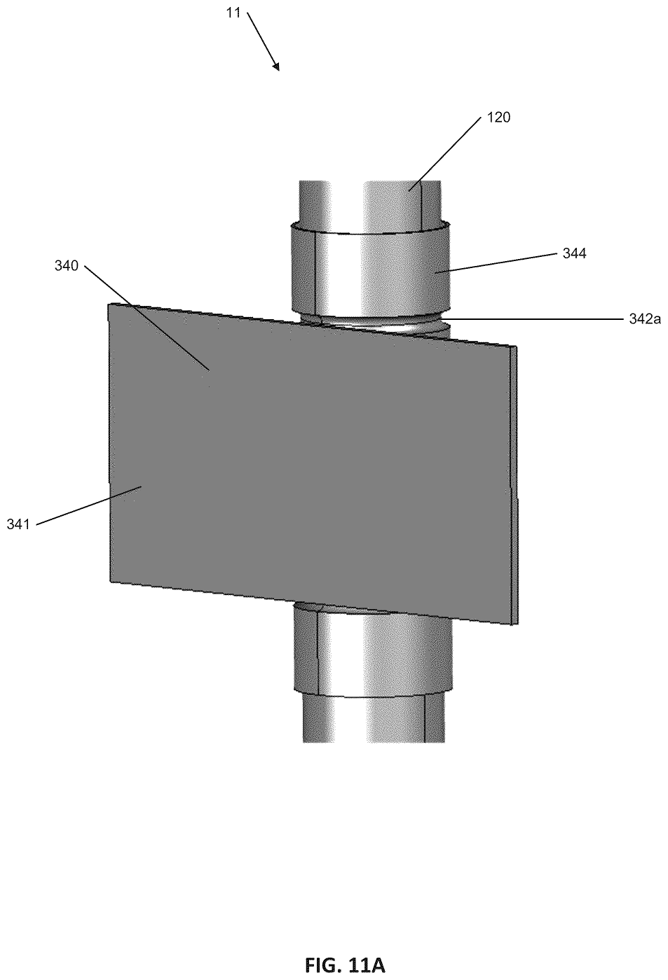

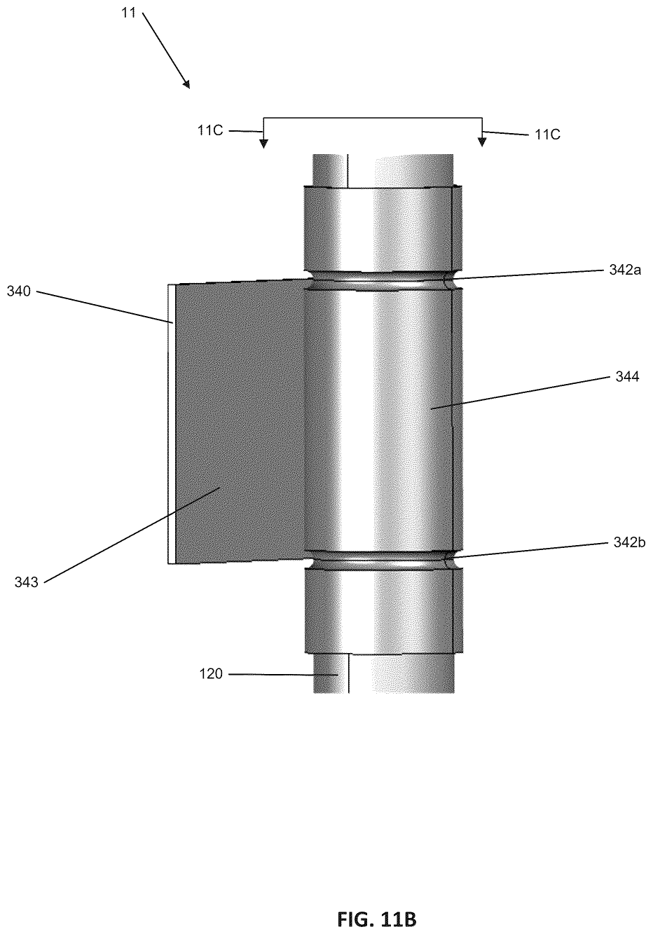

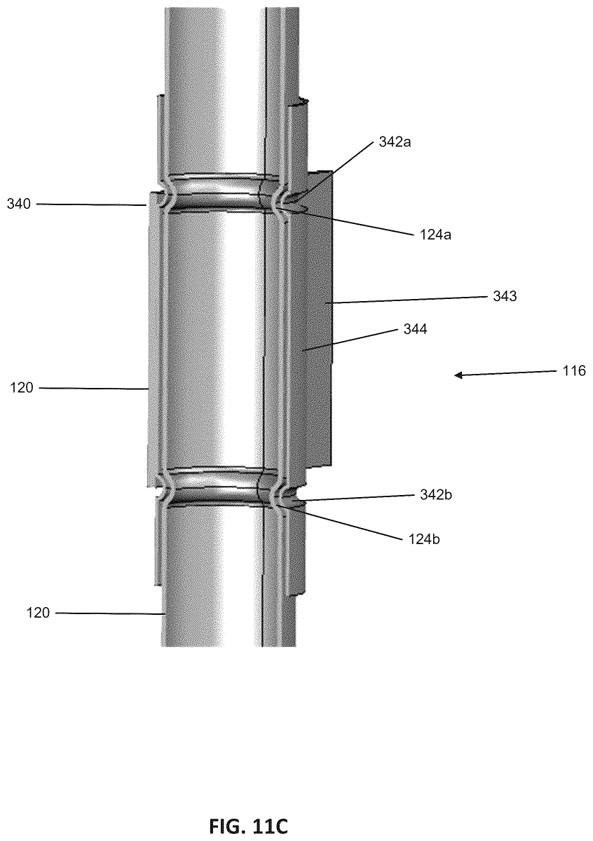

The screw pile 318 differs from pile 118 in that the screw pile 318 may include a stabilizing panel 340. The stabilizing panel 340 (generally referred to herein as panel 340) may be rotatably engaged with the tube 120 while maintaining a stationary position relative to the longitudinal axis L of the tube 120. The panel 340 may include a first surface 341 and a second surface 343 opposite the first surface 341. The second, opposing surface 343 may be radially outward of the first surface 341 relative to the longitudinal axis L of the tube 120. The tube 120 may include the one or more grooves 124a, 124b (shown further in FIG. 11C). The stabilizing panel 340 may be connected to the tube 120 via a sleeve 344. The sleeve 344 may include one or more grooves 342a, 342b that may each be configured to rotatably engage with the one or more grooves 124a, 124b of the tube 120 and configured to ride within a corresponding one of the one or more grooves 124a, 124b, respectively, of the tube 120, such that the panel 340 is continuously rotatable around the entire tube 120. The panel 340 may be fixedly connected to the sleeve 344 via welding, adhesives, hydroforming, or the like.

The pile 318 may be formed from aluminum, brass, carbon, stainless steel, copper, or other metal alloys. In some cases, the pile 318 may be formed via a hydroforming process. In such cases, the pile 318 may be formed of a material and a thickness appropriate for forming the particular components (e.g., blades) described herein. In some cases, the pile 318 may be formed via extrusion, welding, molding, and or any other suitable process. The addition of retention features (e.g., blades 130) to the pile 318 during the manufacturing process may be advantageous in diverse soil conditions soil conditions (e.g., sandy soil, clay soil, silt soil, peat soil, loam soil, among others) by providing reliable support for solar trackers 10 in rural and/or urban environments.

In some examples, the stabilizing panel 340 may be positioned along the central longitudinal axis L at a longitudinal position closer to the central portion 116. The position of the panel 340 may be such that the one or more blades 130 will not overlap longitudinally with the stabilizing panel 340. The longitudinal position of the stabilizing panel 340 may remain consistent when the tube 120 rotates relative to the stabilizing panel 340. In some examples, the panel 340 may be positioned along the central longitudinal axis L at a longitudinal position closer to the first end 117 than a longitudinal position of the one or more blades 130.

FIG. 11A is an enlarged view of a portion of the pile 318 shown in box 11, FIG. 11B is an enlarged rear view of the portion of the screw pile 318, and FIG. 11C is a cross-sectional view of the portion of the pile 318 as in FIG. 11B, take at line 11C-11C. As discussed, the panel 340 may include the first surface 341 and the second surface 343 opposite the first surface 341. The second, opposing surface 343 may be radially outward of the first surface 341 relative to the longitudinal axis L of the tube 120. The tube 120 may include the one or more grooves 124a, 124b. The stabilizing panel 340 may connect to the tube 120 via the one or more grooves 342a, 342b of the sleeve 344 that may ride within the one or more grooves 124a, 124b, respectively, as shown in FIG. 11C. The one or more grooves 342a, 342b of the sleeve 344 are positioned within the grooves 124a, 124b such that the sleeve 344, and thereby the panel 340, move freely and independent of the tube 120. In some examples, the stabilizing panel 340 is rotatable relative to the tube 120 at an offset distance OD from the outer surface 121 of the tube 120, (see, FIG. 5A, for example). In some examples, the blade distance BD (FIG. 4) is greater than the offset distance OD. In other examples, the blade distance BD is equal to or less than the offset distance OD.

As previously stated, the one or more grooves 124a, 124b of the tube 120 and the one or more grooves 342a, 342b of the sleeve 344 may cooperate to permit rotation of the panel 340 relative to the tube 120 while maintaining the orientation of the panel 440 relative to the central longitudinal axis L of the tube 120, such that the panel 340 may be continuously rotatable around the entire tube 120.

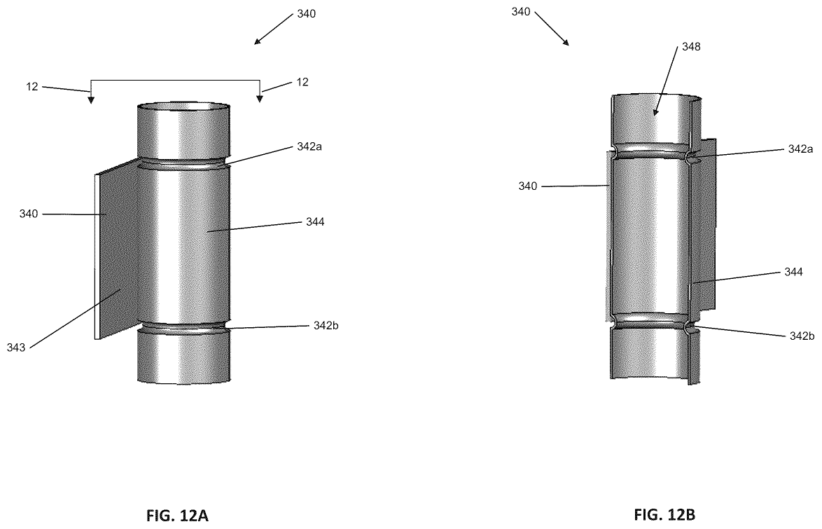

In some examples, the sleeve 344 may be coupled to the tube 120 via a crimping process. For example, the sleeve 344 may be hollow (as shown in FIG. 12B) and may be positioned over the tube 120 and moved to a position over the tube 120 that includes the one or more grooves 124a, 124b. The sleeve 344 may then be crimped, molded, formed such that the one or more grooves 324a, 324b of the sleeve 344 fit within the one or more grooves 124a, 124b of the tube 120. In some examples, the sleeve 344 may be formed around the tube 120 and welded or snapped closed around the tube 120. In other examples, the sleeve 344 may be formed of a resilient material and may include an opening that may permit the tube 120 to pass therethrough, and once the tube 120 has passed through the opening, the sleeve 344 may move to a closed position around the tube 120.

FIG. 12A is a perspective view of the panel 340, and FIG. 12B is a cross-sectional view of the panel 340, taken at line 12-12. As mentioned in reference to FIGS. 11A to 11C, the sleeve 344 may be a hollow sleeve 344, as indicated by 348. The sleeve 344 may be formed with the one or more grooves 324a, 324b configured to correspond to the one or more grooves 124a, 124b of the tube 120. The sleeve 344 may be formed via crimping, heat molding, hydroforming, blow molding, or the like.

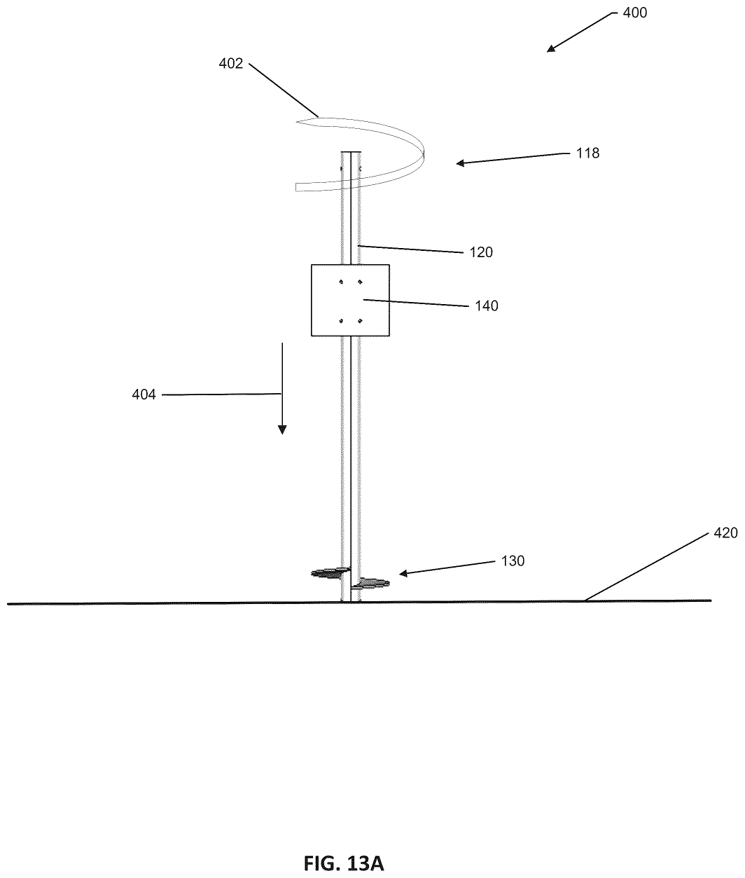

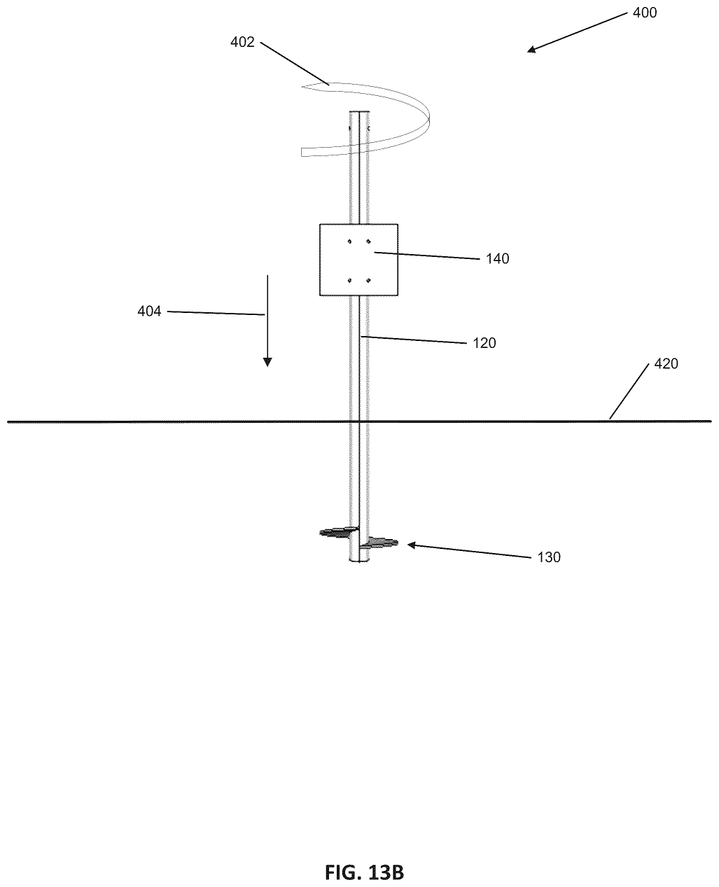

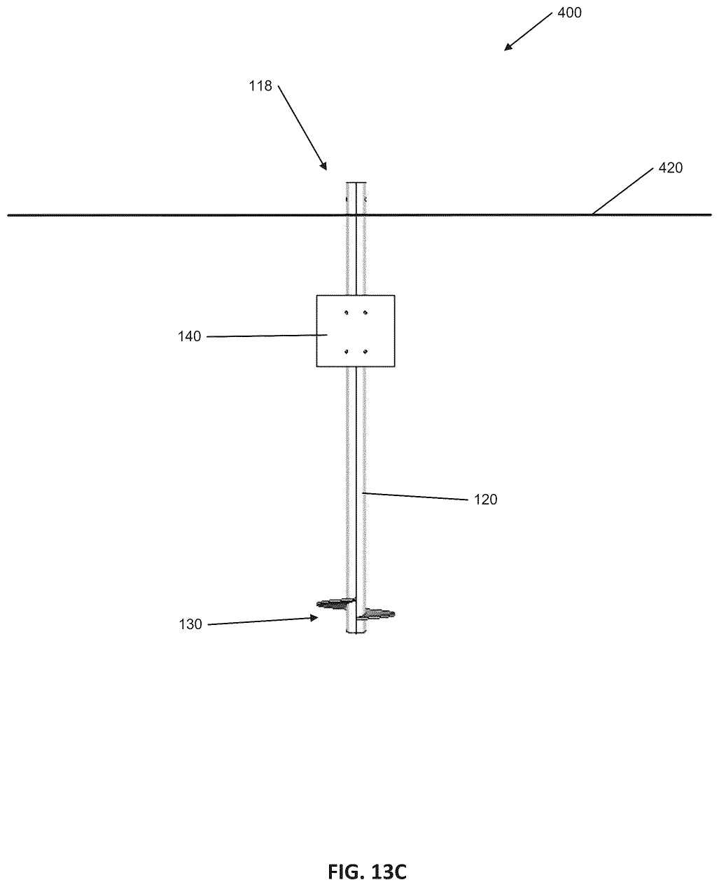

FIGS. 13A to 13C illustrate a method 400 of use for the pile 118 in accordance with the present disclosure. While it is illustrated that the method 300 may be utilized for the pile 118, it may be contemplated that the method 400 may further be utilized for the pile 218 and the pile 318. The pile 118 is merely used as an example.

As shown in FIG. 13A, the pile 118 is positioned adjacent a ground 420 in which the pile 118 is intended to be installed. The ground 420 may be, for example, a soil such as sandy soil, clay soil, silt soil, peat soil, loam soil, among others. Installation of the pile 118 into the ground 420 may require rotation, as indicated by arrow 302, and a downward force, as indicated by arrow 404. Thus, the pile 118 may be configured to be screwed or threaded into the ground 420 to anchor the solar tracker 10 via rotational force. Rotation of the tube 120 (e.g., pile 118) relative to underlying ground 420 may cause the blades 130 to pull the tube 120 further underground, as shown in FIGS. 13B and 13C. While the tube 120 is configured to be screwed into the ground 420, the panel 140 remains stationary. However, the panel 140 is coupled to the tube 120 via the grooves 124a, 124b and the u-brackets 142a, 142b. Thus, pulling of the tube 120 further underground also pulls the stabilizing panel 140 underground, as shown in FIG. 13C. The stabilizing panel 140 may serve to provide support to the tube 120 to help prevent the tube 120 from tipping over in the ground 420 in which the tube 120 is implanted. The panel 140 may further provide high lateral stability and resistance to dynamic loads and may be well-suited for solar tracker installations in regions prone to wind gusts and seismic activity. The same process is followed for other embodiments of the pile (e.g., pile 218, pile 318) disclosed herein.

Various non-limiting exemplary embodiments have been described. It will be appreciated that suitable alternatives are possible without departing from the scope of the examples described herein.

1. An anti-tip ground pile for a solar tracking system, comprising:
an elongate tube extending longitudinally from a first end to a second end, the tube having an outer surface and having a central longitudinal axis;
one or more blades formed along the tube, the one or more blades for engaging with ground in which the ground pile is implanted; and
a stabilizing panel rotatably engaged with the tube such that the stabilizing panel is continuously rotatable around the entire tube, the stabilizing panel being positioned along the central longitudinal axis at a longitudinal position closer to the first end than a longitudinal position of the one or more blades, the stabilizing panel providing support to the tube to help prevent the tube from tipping over in soil in which the tube is implanted.

2. The anti-tip ground pile of claim 1, wherein the stabilizing panel has a first surface and a second surface, opposite the first surface, the second surface being radially outward of the first surface relative to the central longitudinal axis by a thickness, the thickness being less than a height or width of the first surface or the second surface.

3. The anti-tip ground pile of claim 1, wherein the stabilizing panel has a first surface and a second surface, opposite the first surface, the second surface being radially outward of the first surface relative to the central longitudinal axis, the stabilizing panel having a height measured in a directional parallel to the central longitudinal axis and a width measured in a direction perpendicular to the central longitudinal axis, and the tube having a diameter, the height and the width being greater than the diameter.

4. The anti-tip ground pile of claim 1, wherein the stabilizing panel connects to the tube via one or more U-brackets, the one or more U-brackets riding in grooves in the tube, the grooves and the one or more U-brackets cooperating to permit rotation of the stabilizing panel relative to the tube while maintaining orientation of the stabilizing panel relative to the central longitudinal axis of the tube.

5. The anti-tip ground pile of claim 1, wherein a portion of the stabilizing panel extends at least partially around the tube.

6. The anti-tip ground pile of claim 5, wherein the portion of the stabilizing panel is U-shaped or C-shaped.

7. The anti-tip ground pile of claim 1, wherein the one or more blades formed along the tube includes a helical blade formed adjacent to the second end of the tube.

8. The anti-tip ground pile of claim 1, wherein the one or more blades do not overlap longitudinally with the stabilizing panel.

9. An anti-tip ground pile for a solar tracking system, comprising:
an elongate tube extending longitudinally from a first end to a second end, the tube having an outer surface and a central longitudinal axis;
one or more grooves formed in the tube;
one or more helical blades formed along the tube, the one or more blades for engaging with ground in which the ground pile is implanted; and
a stabilizing panel connected to a sleeve, the sleeve formed with one or more grooves, each of the one or more grooves of the sleeve rotatably engaged with and configured to ride within a corresponding one of the one or more grooves of the tube such that the stabilizing panel is continuously rotatable around the entire tube, the stabilizing panel providing support to the tube to help prevent the tube from tipping over in soil in which the tube is implanted.

10. The anti-tip ground pile of claim 9, wherein the stabilizing panel is formed by first, second, and third portions, the third portion extending at least partially around the tube, the first and second portions extending in opposing directions away from the third portion.

11. The anti-tip ground pile of claim 10, further including one or more fasteners connected to the stabilizing panel to maintain the extension of the third portion at least partially around the tube.

12. The anti-tip ground pile of claim 9, wherein the tube includes a first ring bracket located on a first axial side of the stabilizing panel and a second ring bracket located on a second axial side of the stabilizing panel, the first side and the second side being spaced apart axially along the central longitudinal axis L, the first ring bracket and the second ring bracket functioning as axial stops for the stabilizing panel that maintain the stabilizing panel axially between the first ring bracket and the second ring bracket.

13. The anti-tip ground pile of claim 12, wherein a radial distance from the central longitudinal axis L to the first ring bracket and the second ring bracket is greater than the radial distance to the outer surface of the tube between the first ring bracket and the second ring bracket.

14. The anti-tip ground pile of claim 9, wherein rotation of the tube relative to underlying ground causes the one or more blades to pull the tube further underground, the pulling of the tube further underground pulling the stabilizing panel underground.

15. The anti-tip ground pile of claim 9, wherein:
the one or more blades extend away a blade distance from the outer surface of the tube;
the stabilizing panel is rotatable relative to the tube at an offset distance from the outer surface of the tube; and
the blade distance is greater than the offset distance.

16. The anti-tip ground pile of claim 9, wherein the first end of the tube includes a mount for attaching solar tracking components.

17. A method of placing an anti-tip ground pile, the method comprising:
positioning the anti-tip ground pile adjacent to a ground in which the anti-tip ground pile is to be implanted, the anti-tip ground pile comprising:
an elongate tube extending longitudinally from a first end to a second end, the tube having an outer surface and having a central longitudinal axis;
one or more blades formed along the tube, the one or more blades for engaging with ground in which the ground pile is implanted; and
a stabilizing panel rotatably engaged with the tube such that the stabilizing panel is continuously rotatable around the entire tube, the stabilizing panel being positioned along the central longitudinal axis at a longitudinal position closer to the first end than a longitudinal position of the one or more blades;
engaging the ground with the anti-tip ground pile;
rotating the tube relative to the ground causing the one or more blades to rotate, the rotation of the one or more blades pulling the anti-tip ground pile underground;
engaging the stabilizing panel with the ground, wherein the stabilizing panel does not rotate while the tube continues rotation, the continuing rotation providing a force towards pulling the stabilizing panel underground, the stabilizing panel helping prevent the anti-tip ground pile from tipping over when in the ground.

18. The method of claim 17, wherein the longitudinal position of the stabilizing panel remains consistent when the tube is rotated relative to the stabilizing panel.

19. The method of claim 17, wherein:
the stabilizing panel has a first and second opposing surfaces;
the second opposing surface being radially outward of the first opposing surface relative to the central longitudinal axis; and
an orientation of the first and second surfaces relative to the central longitudinal axis remaining consistent when the tube is rotated relative to the stabilizing panel.

20. The method of claim 17, wherein:
the first end of the tube includes a first mounting hole; and
rotating the tube further comprises engaging a motor with the first end of the tube and the first mounting hole to rotate the tube for implantation into the ground.
